(19) United States
(12) Patent Application Publication
(10) Pub. No.: US 2026/0116714 A1
(43) Pub. Date: Apr. 30, 2026

(54) LIFTING APPARATUS AND LIFTING SYSTEM

(71) Applicant: ABB SCHWEIZ AG, Baden (CH)

(72) Inventors: Pushuang Xu, Shanghai (CN); Zhijun Ding, Shanghai (CN); Zhenghao Dong, Shanghai (CN)

(21) Appl. No.: 19/372,583

(22) Filed: Oct. 29, 2025

Related U.S. Application Data
(63) Continuation of application No. PCT/CN2023/092376, filed on May 5, 2023.

(51) Int. Cl. B66F 3/44

(52) U.S. Cl. CPC B66F 3/44

(57) ABSTRACT

A lifting apparatus, including a pallet configured to support an object and including a plurality of pallet pivots; a motor; and a plurality of rotating members coupled to a respective pallet pivot, each including: a first linkage pivot coupled to a base; a second linkage pivot coupled to the motor; and a third linkage pivot; a plurality of transmitting members coupled to a respective pallet pivot and a respective rotating member, each including: a fourth linkage pivot coupled to the third linkage pivot of the rotating member; and a fifth linkage pivot coupled to a respective one of the plurality of pallet pivots.

### FIELD

Example embodiments of the present disclosure generally relate to the industrial field, and more particularly, to a lifting apparatus and a corresponding lifting system.

### BACKGROUND

In the manufacture of industrials, automated guided vehicles (AGVs) are becoming more and more widely used in various scenarios, such as transferring parts in factories or moving goods in warehouses. In the working process of AGV, a lifting movement of the pallet is an important function, which can lift a variety of goods to desired positions in a convenient manner.

In order to realize the lifting movement of AGV pallet, a plurality of different mechanical structure forms can be adopted. For example, ball screw structure is adopted to convert the rotary motion into a lifting linear motion. However, the space structure is not compact and the cost is relatively high. In the actual applications, the details of the structure are also different, which limits the application scope of the approach.

### SUMMARY

In general, example embodiments of the present disclosure provide a lifting apparatus and a corresponding lifting system, which address the existing problems and/or any potential problems.

In a first aspect, there is provided a lifting apparatus. The lifting apparatus comprises a pallet configured to support an object and comprising a plurality of pallet pivots; a motor; and a plurality of rotating members coupled to a respective pallet pivot, each comprising: a first linkage pivot coupled to a base; a second linkage pivot coupled to the motor; and a third linkage pivot; a plurality of transmitting members coupled to a respective pallet pivot and a respective rotating member, each comprising: a fourth linkage pivot coupled to the third linkage pivot of the rotating member; and a fifth linkage pivot coupled to a respective one of the plurality of pallet pivots.

According to the example embodiments of the present disclosure, the compact structure and low cost of the lifting apparatus can be achieved, and the assembly and structural stability can also be improved.

In some example embodiments, a first distance between the rotating member pivot and the third linkage pivot and a second distance between the rotating member pivot and the second linkage pivot is at least determined by a power of the motor and/or a required lifting stroke of the pallet.

In some example embodiments, one rotating member of the plurality of rotating members is coupled to a driving arm of the motor, and other rotating members of the plurality of rotating members are coupled to the one rotating member via at least one connecting arm.

In some example embodiments, the lifting apparatus further comprises a plurality of first connecting arm with one end coupled to the base and the other end coupled to one of the plurality of pallet pivots.

In some example embodiments, each of the plurality of transmitting members are of C-shaped, with the fourth linkage pivot coupled to the third linkage pivot of the rotating member; and the fifth linkage pivot coupled to the respective one of the plurality of pallet pivots.

In some example embodiments, the plurality of rotating members are of the same shape and/or the same dimension.

In some example embodiments, the plurality of transmitting members are of the same shape and/or the same dimension.

In some example embodiments, the plurality of rotating members are evenly distributed about the pallet.

In some example embodiments, the plurality of pallet pivots are evenly distributed about the pallet.

In a second aspect, there is provided a lifting system. The lifting system comprises a lifting apparatus in the first aspect.

### BRIEF DESCRIPTION OF THE DRAWINGS

Through the following detailed description with reference to the accompanying drawings, the above and other objectives, features and advantages of the example embodiments disclosed herein will become more comprehensible. In the drawings, several example embodiments disclosed herein will be illustrated in an exemplary and in a non-limiting manner, wherein:

FIG. 1 illustrates a perspective view of the lifting apparatus in accordance with an example embodiment of the present disclosure;

FIG. 2 illustrates an exploded view of the lifting apparatus in accordance with an example embodiment of the present disclosure; and

FIG. 3 illustrates a perspective view of the rotating member of the lifting apparatus in accordance with an example embodiment of the present disclosure.

Throughout the drawings, the same or similar reference numerals represent the same or similar element.

### DETAILED DESCRIPTION

Principles of the present disclosure will now be described with reference to some example embodiments. It is to be understood that these embodiments are described only for the purpose of illustration and to help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skill in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to apply such feature, structure, or characteristic in connection with other embodiments whether or not explicitly described.

It should be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

A variety of approaches have been proposed to lift the objects to desired positions in goods transferring industry. The conventional approaches mainly use ball screw structure or crank rocker lifting structure to lift the goods. As described above, the conventional approaches still have many disadvantages.

For example, for the ball screw structure, the space utilization rate is relatively low, especially in latent AGVs, the height of the AGV will be limited, and using the ball screw structure limits the reduction of the height size of AGVs. Moreover, the parts of the ball screw generally use alloy steel, and the alloy steel requires a large number of heat treatment and grinding processes, so the material cost and processing cost are high. Worse still, the ball screw lifting structure requires the use of lubricating grease, and the grease may volatilize and sputter during rotation, which will generate a risk of environmental contamination.

For the crank rocker lifting structure, since the number of parts is large, it is inconvenient for installation and maintenance. Moreover, there may be over constrained for the existing crank rocker lifting structure, the dimensional tolerance of the parts is high to ensure the precise assembly. Worse still, when parallelogram mechanism of the crank rocker lifting structure is pulled, the force point of the pull is mostly on the outside of the joint, which will reduce the force stability.

At least to address the problem existed in the conventional approaches, the present disclosure proposes a solution involving a lifting apparatus and a corresponding lifting system, which greatly saves the space occupied by the lifting apparatus.

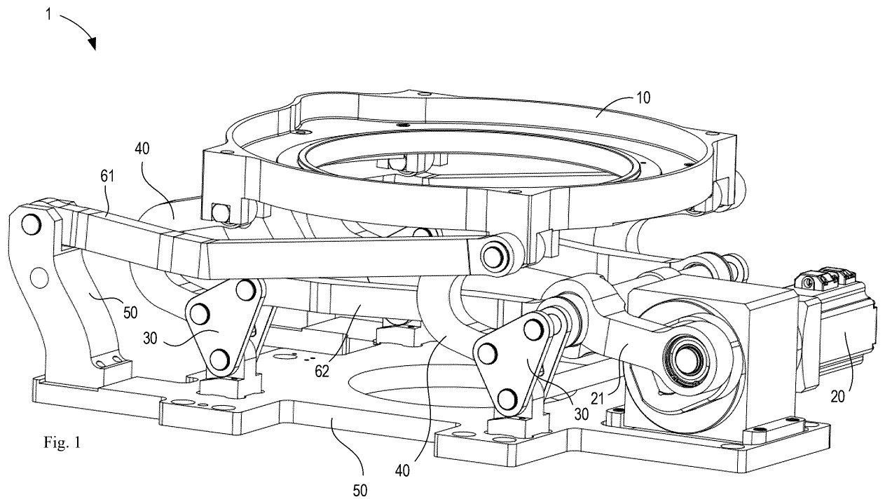

Example embodiments of the present disclosure will be described in more detail hereinafter in accordance with FIGS. 1-3. With reference to FIG. 1 at first, which illustrates a perspective view of the lifting apparatus 1 in accordance with an example embodiment of the present disclosure.

The lifting apparatus 1 generally includes a pallet 10, a motor 20 and a series of transmission components coupled between the pallet 10 and the motor 20. The pallet 10 may be used to support an object and by means of the motor 20, the object can be moved to any desired positions and desired height. The object can be any type of objects that are intended to be supported or delivered by the lifting apparatus 1. The specific type and the shape of the object are not limited to embodiments of the present disclosure.

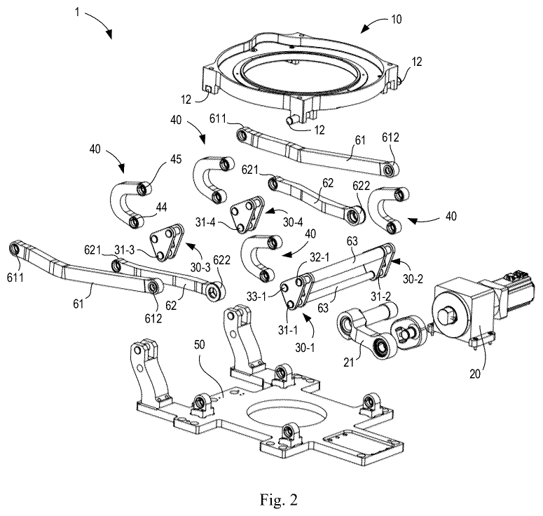

FIG. 2 illustrates an exploded view of the lifting apparatus 1 in accordance with an example embodiment of the present disclosure. As shown, the pallet 10 includes four pallet pivots 12. It is to be understood that the number of the pallet pivots 12 is merely example without suggesting any limitation as to the scope of the present disclosure. In other example embodiments, according to the actual need of users, other numbers of pallet pivots 12 can be provided, for example, three, five, six or even more.

The transmission components coupled between the pallet 10 and the motor 20 generally include a plurality of rotating members 30 and a plurality of corresponding transmitting members 40. As shown in FIG. 2, four rotating members 30 and corresponding transmitting members 40 are included. It is to be understood that the number of the rotating members 30 and number of the transmitting member 40 may match the number of the pallet pivots 12. If the number of the pallet pivots 12 is changed, the numbers of the rotating members 30 and the transmitting member 40 may be adjusted accordingly.

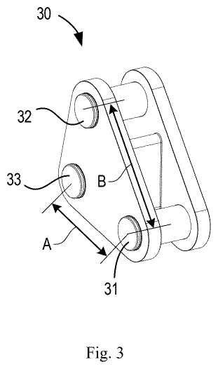

FIG. 3 illustrates a perspective view of the rotating member in accordance with an example embodiment of the present disclosure. Example embodiments of the rotating member 30 according to the present disclosure are shown in FIG. 3. With reference in combination with FIG. 2, the rotating member 30 is substantially of a triangle shape and has three pivots, i.e., a first linkage pivot 31, a second linkage pivot 32 and a third linkage pivot 33. Among the three pivots, the first linkage pivot 31 is coupled to a base 50. In some example embodiments, the base 50 may be a ground. In some example embodiments, the base 50 may be a platform on which the lifting apparatus 1 is mounted. In other example embodiments, the base 50 include a stationary part fixedly mounted to the platform. With the first linkage pivot 31 mounted to the base 50, the rotating member 30 may rotate about the first linkage pivot 31 relative to the base 50. The second linkage pivot 32 may be mounted to the motor 20. Among the four rotating member 30, one rotating member 30-1 is coupled to the motor 20 directly and other three rotating members 30-2, 30-3, 30-4 are coupled to the motor 20 indirectly by means of a series of linkages. The motor 20 may be driven to cause the rotation of the rotating member 30-1, and the rotation may cause the movements of other three rotating members 30, which will be described in more detail hereinafter.

As can be seen from FIG. 2, each of the plurality of transmitting members 40 is coupled to a respective pallet pivot 12 and a respective rotating member 30. Each transmitting member 40 is substantially of a C shape and includes two linkage pivots at each end of the C shape, i.e., a fourth linkage pivot 44 and a fifth linkage pivot 45. The fourth linkage pivot 44 may be coupled to the third linkage pivot 33 of the rotating member 30. The fifth linkage pivot 45 may be coupled to a respective one of the plurality of pallet pivots 12.

In the illustrated embodiment, the four rotating members 30 are of the same shape and may be different from each other only in their specific locations. In the illustrated embodiments, the four transmitting members 40 are of the same shape. In this manner, the four rotating member 30 may move synchronously with a same pace and the four transmitting members 40 may also move synchronously with a same pace. As a result, the pallet 10 can be kept horizontally in operation to avoid the object on it from being fallen.

The lifting apparatus 1 may also include at least one first connecting arm 61 to couple the pallet 10 to the base 50. As shown in FIG. 1, the first connecting arm 61 has two ends, with one end 611 coupled to the base 50 and the other end 612 coupled to one pallet pivot 12 of the pallet 10. In the illustrated embodiments, the two first connecting arms 61 are of the same shape and are symmetrically provided. It is to be understood that in other example embodiments, the first connecting arms 61 may be different from each other in shapes and dimensions. In addition, the shape of the first connecting arm 61 as shown in the figure is merely for illustrative purpose, rather than restrictive. Other shapes of the first connecting arm 61 are also possible, as long as they can used to achieve the motion transmission function between the base 50 and the pallet 10.

The lifting apparatus 1 may also include at least one second connecting arm 62 to couple two rotating members 30. As shown in FIGS. 1 and 2, the second connecting arm 62 has two ends, with one end 621 coupled to one second linkage pivot 32 and the other end 622 coupled to another second linkage pivot 32. In the illustrated embodiments, the two second connecting arm 62 are of the same shape and are symmetrically provided. It is to be understood that in other example embodiments, the second connecting arm 62 may be different from each other in shapes and dimensions. In addition, the shape of the second connecting arm 62 as shown in the figure is merely for illustrative purpose, rather than restrictive. Other shapes of the second connecting arm 62 are also possible, as long as they can used to achieve the motion transmission function between the two rotating members 30.

The example working procedure of the lifting apparatus 1 will be described in detail below with reference to FIGS. 1-2.

The motor 20 may drive the rotating member 30-1 to rotate about the first linkage pivot 31-1 via the driving arm 21. The rotation of the rotating member 30-1 will cause the rotating member 30-2 to rotate about the first linkage pivot 31-2 via the third connecting arms 63. The rotation of the rotating member 30-1 will also cause the rotating member 30-3 to rotate about the first linkage pivot 31-3 via the second connecting arm 62. The rotation of the rotating member 30-2 will also cause the rotating member 30-4 to rotate about the first linkage pivot 31-4 via the other second connecting arm 62. Therefore, the four rotating members 30 will rotate synchronously.

For each rotating member 30, since the third linkage pivot 33 is connected to a respective fourth linkage pivot 44 of the respective transmitting member 40. Therefore, the four transmitting member 40 will rotate synchronously. For each transmitting member 40, since the fifth linkage pivot is couple to a respective pallet pivot 12 of the pallet 10, the pallet 10 will be actuated to any desired location.

In other example embodiments, the rotating members 30 may be different from each other in shapes or dimensions, according to the actual need of the users. In other example embodiments, the transmitting members 40 may be different from each other in shapes or dimensions, according to the actual need of the users.

As illustrated in FIG. 3, the distance between the rotating member pivot 31 and the third linkage pivot 33 is marked as a first distance A, and the distance between the rotating member pivot 31 and the second linkage pivot 32 is marked as a second distance B. In some example embodiments, the relationship between the first distance A and the second distance B may be determined by a power of the motor 20. In other example embodiments, the relationship between the first distance A and the second distance B may also be determined a required lifting stroke of the pallet 10. In some example embodiments, the determination can be carried out according to the experience of the users. In other example embodiments, the determination can be carried out by simulation or experimental methods. In this manner, when the power of the motor 20 and/or the required lifting stroke of the pallet 10 is determined, the relationships between the first distance A and the second distance B can be determined accordingly to ensure the optimal transmission performance to be achieved.

According to example embodiments of the present disclosure, the rotating member 30 adopts a triangle shape to allow its three joints to integrate support linkage and the pull linkage into one part. In this way, the number of parts may be reduced and the costs can be saved. Since the number of the parts may be reduced, the whole lifting apparatus 1 can have a more compact space structure.

In some example embodiments, the plurality of rotating members 30 are evenly distributed about the pallet 10. For example, the plurality of rotating members 30 are spaced from each other at a central angle of 90 degrees. In further example embodiments, the plurality of pallet pivots 12 are evenly distributed about the pallet 10. For example, the plurality of pallet pivots 12 are spaced from each other at a central angle of 90 degrees. In this manner, the pallet 10 can be kept stably when being actuated. Therefore, the object on the pallet 10 can be transferred smoothly and steadily.

As can be seen from FIG. 2, as the space can be saved by using the rotating members 30, the intervals of the connecting arms 61, 62 can be arranged much larger, so that the pallet 10 is better stressed and is thus more stable.

According to the example embodiments of the present disclosure, when the connecting arms of this structure pulls the parallelogram mechanism, the force point of the pull is located on the inside of the pivot, so that the force of the entire lifting apparatus 1 is stable.

As can be seen from FIG. 2, there is no connecting arms between the rotating arm 30-3 and the rotating arm 30-4. Since these two rotating arms are independent of each other, the degree of over-constraint freedom of the lifting apparatus 1 can be reduced and the difficulty of assembling and maintenance can be reduced. In addition, since these two rotating arms 30-3, 30-4 are independent of each other, the internal space on the lower side of the pallet 10 can be increased, which facilitates the arrangement of components of the lifting apparatus 1.

Compared with the conventional approach using lubricating grease, the example embodiments according to the present disclosure uses self-lubricating plain bearings, which can further avoid the risk of environmental pollution. It is to be understood that although the above disclosure are described by taking the object transferring scenario as examples, this is only for illustration without suggesting any limitations as to the scope of the subject matter described here the above embodiments may be used in other scenarios.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. On the other hand, various features that are described in the context of a single embodiment may also be implemented in multiple embodiments separately or in any suitable sub-combination.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A lifting apparatus, comprising:
a pallet configured to support an object and comprising a plurality of pallet pivots;
a motor; and
a plurality of rotating members coupled to a respective pallet pivot each comprising:
a first linkage pivot coupled to a base;
a second linkage pivot coupled to the motor; and
a third linkage pivot;
a plurality of transmitting members coupled to a respective pallet pivot and a respective rotating member each comprising:
a fourth linkage pivot coupled to the third linkage pivot of the rotating member; and
a fifth linkage pivot coupled to a respective one of the plurality of pallet pivots.

2. The lifting apparatus according to claim 1, wherein a first distance between the rotating member pivot and the third linkage pivot and a second distance between the rotating member pivot and the second linkage pivot is at least determined by a power of the motor and/or a required lifting stroke of the pallet.

3. The lifting apparatus according to claim 1, wherein one rotating member of the plurality of rotating members is coupled to a driving arm of the motor and other rotating members of the plurality of rotating members are coupled to the one rotating member via at least one connecting arm.

4. The lifting apparatus according to claim 1, further comprising a plurality of first connecting arm with one end coupled to the base and the other end coupled to one of the plurality of pallet pivots.

5. The lifting apparatus according to claim 1, wherein each of the plurality of transmitting members are of C-shaped, with the fourth linkage pivot coupled to the third linkage pivot of the rotating member; and the fifth linkage pivot coupled to the respective one of the plurality of pallet pivots.

6. The lifting apparatus according to claim 1, wherein the plurality of rotating members are of the same shape and/or the same dimension.

7. The lifting apparatus according to claim 1, wherein the plurality of transmitting members are of the same shape and/or the same dimension.

8. The lifting apparatus according to claim 1, wherein the plurality of rotating members are evenly distributed about the pallet.

9. The lifting apparatus according to claim 1, wherein the plurality of pallet pivots are evenly distributed about the pallet.

10. A lifting system comprising the lifting apparatus according to claim 1.
